(19) United States
(12) Patent Application Publication
(10) Pub. No.: US 2016/0078552 A1
(43) Pub. Date: Mar. 17, 2016

(54) SYSTEM AND METHOD FOR FORECASTING PAYMENTS OF HEALTHCARE CLAIMS

(71) Applicant: Medworth, LLC, Mobile, AL (US)

(72) Inventors: David Boyd Mercer, Spanish Fort, AL (US); Thomas Cookson Myers, JR., Mobile, AL (US)

(21) Appl. No.: 14/946,432

(22) Filed: Nov. 19, 2015

Related U.S. Application Data
(63) Continuation of application No. 13/193,509, filed on Jul. 28, 2011, now abandoned.

(51) Int. Cl. G06Q 40/08

(52) U.S. Cl. CPC G06Q 40/08; G06Q 50/22

(57) ABSTRACT

Systems and methods are provided for forecasting remittances of a target claim filed for reimbursement of a healthcare service provided to an insured patient. A set of data associated with the target claim is extracted from a database. A claim value engine queries the database using the set of data, and based on the query, selects a plurality of claims from the database that are associated with the service provider and the claim payer of the target claim, are older than the target claim by at least a predetermined period of time, and have a previous remittance status similar to that of the target claim. The claim value engine also evaluates a mean expectation value for a predetermined date based on the reimbursement amounts for the selected plurality of claims, and determines a net reimbursement of the target claim by multiplying the evaluated mean expectation value by the claim amount.

### CROSS REFERENCE

This application is a continuation application of U.S. Non-Provisional patent application Ser. No. 13/193,509 which was filed on Jul. 28, 2011, and is incorporated by reference herein in its entirety.

### TECHNICAL FIELD

This invention generally relates to insurance claims for reimbursement of healthcare services, and more particularly relates to a system and method for forecasting payments and remittance times resulting from the filing of an insurance claim or a batch of insurance claims for reimbursement of healthcare services provided to insured patients.

### BACKGROUND OF THE INVENTION

Conventional ways of selling healthcare receivables, which have not proved to be desirably efficient, have lead to high risk for the purchaser/investor and a correspondingly high cost of capital to the seller (typically a hospital). Both of these factors have prevented the creation of a viable market for these receivables. Typically, if a hospital wants to sell its receivables, it works with a single lender who performs lengthy due diligence and typically undervalues outstanding claims due to a lack of information and transparency.

The values of outstanding claims can be improved if their corresponding reimbursements can be accurately forecasted. To hospitals and other healthcare providers, the accurate forecasting of claim reimbursements can help maintain meaningful financial projections and efficiently run their businesses. Not only can accurate forecasts prevent healthcare providers from having to borrow money to meet unexpected cash flow shortfalls, they may also enable providers to reduce their cash reserves, freeing up capital for investment to improve the quality and range of healthcare services being provided to the community. Furthermore, by making such forecasts available to potential lenders, health care providers may be able to obtain lower interest rates on their debt due to the reduced risk the lenders are taking on.

A meaningful forecast desirably predicts the full cash flow resulting from the claim, not just the net amount expected to be received eventually from the payer. The time value of money is obvious when it comes to predicting whether a $100,000 claim will be paid next week or six months hence, but in the health insurance industry, not all cash flows resulting from a claim filing are positive. Moreover, it is not infrequent for payers to review their past reimbursements and make retroactive adjustments to prior payments, known as take-backs, which they obtain by reducing the net amount on a future payment. Meaningful forecasts should accurately account for any expected reductions in cash flows resulting from a claim being filed or paid.

Therefore, there exists a need for a system and method for forecasting cash flows resulting from the filing of an insurance claim or a batch of insurance claims for reimbursement of healthcare services provided to insured patients.

### SUMMARY OF THE INVENTION

The invention is defined by the appended claims. This description summarizes some aspects of the present embodiments and should not be used to limit the claims. At least, the foregoing problems are solved and a technical advance is achieved by a system and method consistent with the invention, which forecast cash flows resulting from the filing of an insurance claim or a batch of insurance claims for reimbursement of healthcare services provided to insured patients.

One embodiment is directed to a method for forecasting remittances of a claim filed for reimbursement of a healthcare service provided to an insured patient. The method includes determining, using a data extraction module running on a processor, a set of data associated with the target claim, the set of data including a service provider, a claim payer, a claim amount, an age, and a remittance status. The method also includes querying, using a claim value engine running on the processor, a database using the set of data associated with the target claim. The method further includes based on said querying, selecting, using the claim value engine, a plurality of claims stored in the database that (i) are associated with the service provider and the claim payer of the target claim, (ii) are older than the target claim by at least a predetermined period of time, and (iii) have a previous remittance status, from when the selected plurality of claims were the age of the target claim, that is the same as the remittance status of the target claim, wherein each of the selected plurality of claims has a claim amount, a plurality of reimbursement amounts, and a plurality of corresponding reimbursement dates. In addition, the method includes evaluating, using the claim value engine, a mean expectation value for a predetermined date based on the plurality of reimbursement amounts of the plurality of claims; and determining, using the claim value engine, a reimbursement value of the target claim that is to be received by the predetermined date by multiplying the evaluated mean expectation value by the claim amount.

Another embodiment sets forth a system for forecasting remittances of a target claim filed for reimbursement of a healthcare service provided to an insured patient, the system comprising a data extraction module configured to extract a set of data associated with the target claim from a claim database, the set of data including a service provider, a claim payer, a claim amount, an age, and a remittance status. The system further comprises a claim value engine configured to: query the claim database using the set of data associated with the target claim; select, based on said query, a plurality of claims stored in the claim database that (i) are associated with the service provider and the claim payer of the target claim, (ii) are older than the target claim by at least a predetermined period of time, and (iii) have a previous remittance status, from when the selected plurality of claims were the age of the target claim, that is the same as the remittance status of the target claim, wherein each of the selected plurality of claims has a claim amount, a plurality of reimbursement amounts, and a plurality of corresponding reimbursement dates; evaluate a mean expectation value for a predetermined date based on the plurality of reimbursement amounts of the plurality of claims; and determine a reimbursement value of the target claim that is to be received by the predetermined date by multiplying the evaluated mean expectation value by the claim amount.

Another embodiment sets forth a system for forecasting remittances of a target claim filed for reimbursement of a healthcare service provided to an insured patient, the system comprising a memory configured to store a database comprising information about a plurality of claims, the information including a claim amount, a plurality of reimbursement amounts, and a plurality of corresponding reimbursement dates for each of the plurality of claims. The system also comprises a processor in communication with the database, the processor for executing (i) a data extraction module configured to extract a set of data associated with the target claim from the database, the set of data including a service provider, a claim payer, a claim amount, an age, and a remittance status, and (ii) a claim value engine configured to: query the database using the set of data associated with the target claim; based on said query; select a subset of the plurality of claims that (1) are associated with the service provider and the claim payer of the target claim, (2) are older than the target claim by at least a predetermined period of time, and (3) have a previous remittance status, from when the selected plurality of claims were the age of the target claim, that is the same as the remittance status of the target claim; evaluate a mean expectation value for a predetermined date based on the plurality of reimbursement amounts of the selected subset of the plurality of claims; and determine a reimbursement value of the target claim to be received by the predetermined date by multiplying the evaluated mean expectation value by the claim amount.

Other systems, methods, features, and advantages of the invention will be, or will become, apparent to one having ordinary skill in the art upon examination of the following drawings and detailed description. It is intended that all such additional articles of manufacture, features, and advantages included within this description, be within the scope of the invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the invention. In the drawings, like reference numerals designate corresponding parts throughout the several views.

FIG. 1 illustrates a block diagram illustrating a networked computing system for collecting and processing credit information associated with consumers for forecasting payments of healthcare claims in accordance with an embodiment of the invention;

FIG. 2 illustrates block diagram illustrating an embodiment of a process involving claim payment information exchange between a health provider and a claim payer;

FIG. 3 illustrates a block diagram illustrating a claim auction system for selling healthcare receivables through an auction process;

FIG. 4 illustrates a block diagram illustrating an embodiment of the auction process of FIG. 3;

FIG. 5 illustrates a flow diagram illustrating an embodiment of a process for creating a forecast model based on a training set of claims and associated remittances in accordance with principles of the invention;

FIG. 6 illustrates a graph depicting a curve of a mean expectation value of a claim reimbursement and a pair of curves depicting a corresponding uncertainty of the claim reimbursement;

FIG. 7 illustrates a graph of a probability of a claim being paid by a desired date in accordance with the invention; and

FIG. 8 illustrates a block diagram illustrating one form of a computer or server of FIG. 1, having a memory element with a computer readable medium for implementing the computing system used for collecting and processing consumer credit information.

Illustrative and exemplary embodiments of the invention are described in further detail below with reference to and in conjunction with the figures.

### DETAILED DESCRIPTION OF THE DRAWINGS

The invention is defined by the appended claims. This description summarizes some aspects of the present embodiments and should not be used to limit the claims. While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

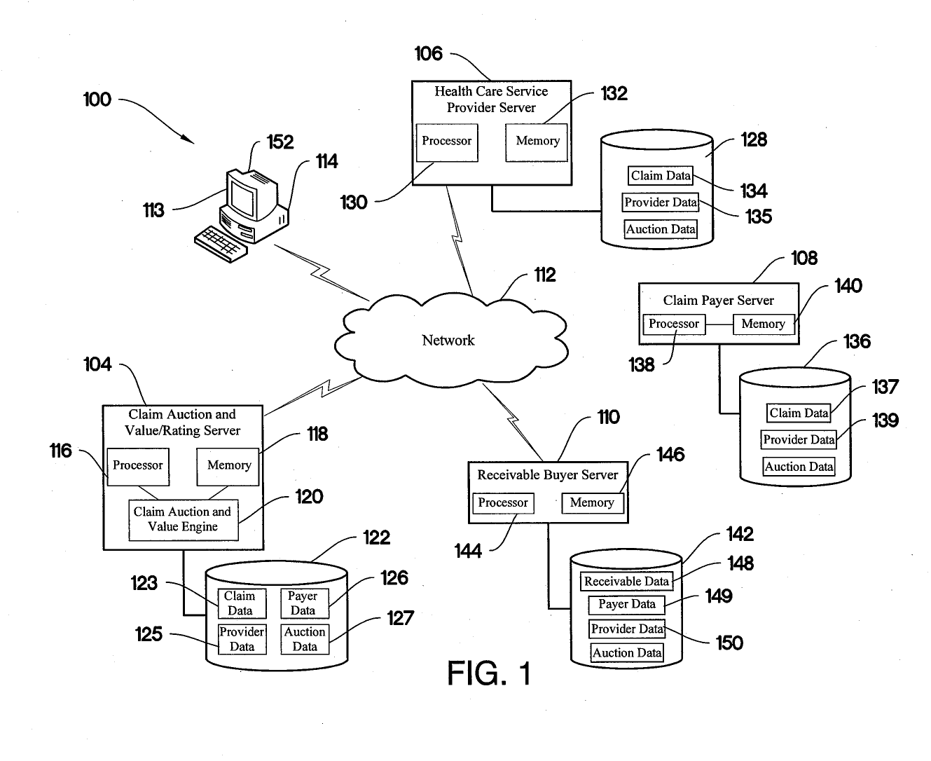

Now referring to FIG. 1, a networked system 100, for forecasting cash flows resulting from the filing of an insurance claim or a batch of insurance claims for reimbursement of healthcare services provided to insured patients, is shown in accordance with a particular embodiment of the invention. In the exemplary embodiment of FIG. 1, the networked system 100 comprises a user computer 102 and a server 104, both communicatively connected to a health care provider server 106, a claim payer server 108, and a receivable buyer server 110 through a network 112 (e.g. the Internet). The user computer 102 may include a computer monitor 113 and a desktop processing unit 114. In the depicted embodiment, the server 104 may include a processor unit 116, a memory unit 118 and a claim value engine unit 120, and is coupled to a database 122. The database 122 includes claim data 123, provider data 125, payer data 126, and auction data 127. The health care provider server 106 is coupled to a database 128, and may include a processor unit 130, a memory unit 132. The database 128 includes claim data 134 and patient data 135. The claim payer server 108 is coupled to a database 136, and may also include a processor unit 138 and a memory unit 140. The database 136 includes claim data 137 and provider data 139. The receivable buyer server 110 is coupled to a database 142, and may also include a processor unit 144 and a memory unit 146. The database 142 includes receivable data 148, payer data 149, and provider data 150. The user computer 102 and the server 104 may be connected through a local area network (LAN). Alternatively, the user computer 102 and the server 104 may be communicatively coupled to one another via a global network, a wide area network (WAN), or an Internet portal. Further, the user computer 102, which is shown as a personal computer, may be a handheld or a portable computing device. The server 104 preferably includes a plurality of programs, including but not limited to programs stored within the memory unit 118 for receiving and processing queries transmitted from the user computer 102 electronically. Similarly, each of the health care server 106 and claim payer server 108 preferably includes a plurality of programs, including but not limited to programs stored within memory units 132 and 140, respectively, for receiving and processing queries transmitted from the user computer 102 and the server 104 electronically. In certain preferred embodiments, the electronic transmission between the health care server 106, claim payer server 108, the user computer 102, the server 104, and the receivable buyer server 110 may occur through File Transfer Protocol (“FTP”), Internet Transfer Protocol (“TCP/IP”) or others. For security reasons, the electronic transmission may occur via dedicated and/or secure communication lines that provide secured file transfers, such as through Secure File Transfer Protocol (“SFTP”) with encryption tools. In one embodiment, the server 104 may be associated with a health care provider business to predict or forecast payments of service rendered to insured patients. In another embodiment, the server 104 may be associated with a business involved in selling healthcare receivables through an auction platform. In either embodiment, the database 104 is configured to maintain claim data 123, health service provider data 125, and claim payer data 126.

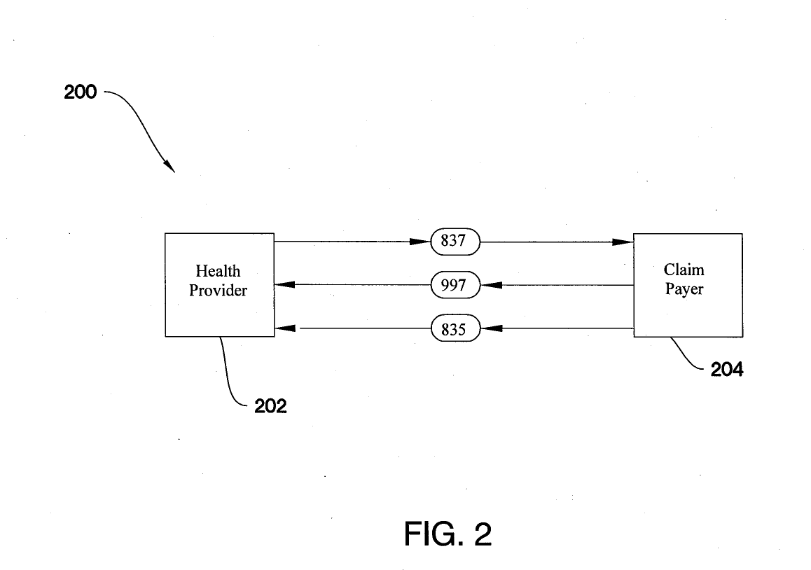

Now referring to FIG. 2, an embodiment of a process 200 involving claim payment information exchange between a health provider 202 and a claim payer 204 is shown. When the healthcare provider 202 provides healthcare services to a patient, payment for the services provided may be paid in full by the patient him/herself or the patient may provide insurance information for the claim payer 204 to pay all or part of the service charges. In the latter case, the healthcare provider 202 files a claim with the patients' insurer or payer 204 to obtain the balance of charges. As shown in this particular embodiment, the healthcare provider 204 submits a claim electronically in the form of a data message through the network 112, such as an electronic interchange (EDI) message, to the claim payer 204. The EDI message may be a health insurance portability and accountability act (HIPAA) EDI health care claim transaction message, also known and referred to as EDI message 837. The claim payer 204 then acknowledges receipt of the submitted claim with a reply EDI message, such as EDI Functional Acknowledgement Transaction set or message 997. Subsequently, after adjudicating the provider's claim, the payer 204 can send another EDI message, such as EDI Health Care Claim Payment/Advice Transaction message 835, advising the provider 202 as to the amount being paid for the claim and the date on which the payment(s) will be issued.

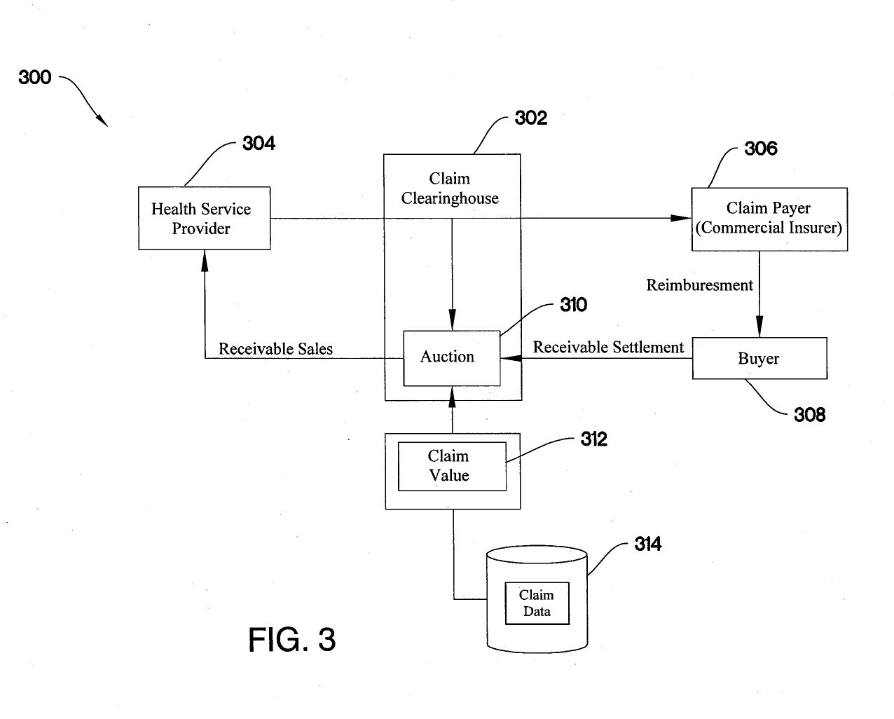

In another embodiment, rather than being submitted directly to the claim payer, the claim can be provided to a claim clearinghouse 302 unit which is part of an auction system 300, shown in FIG. 3. In the auction system 300, the claim clearinghouse unit 302, hereafter referred to as claim clearinghouse, is in communication with a health care provider 304, a claim payer or commercial insurer 306, and a receivable buyer 308. The claim clearinghouse 302, which is configured to support the selling of health care receivables in an efficient manner, utilizes existing or historical electronic claims and payment information as the basis for the auction/trading environment. The claim clearinghouse 302 includes an electronic claim auction module or platform 310 coupled to a claim value engine 312, which in turn is coupled to a claim database 314. In one embodiment, the auction system participants 304-308 may be required to utilize the electronic auction platform claim editing software modules or programs and claim clearinghouse services in order to achieve a level of consistency across the auction system 300. Based on a near real time flow of electronic claims and payments (remittances/reimbursements), the auction platform 310 is also configured to efficiently offer for sale and then track the payments received for sold claims, thereby offering transparency of data to the parties or participants involved 304-308.

In accordance with a particular embodiment of the invention, the claim value engine 312 is configured to determine a rating of each individual claim or claims, which is to be transacted over the electronic auction platform 310. The claim rating represents a statistical prediction of the net reimbursement for the corresponding healthcare claim, which represents a comprehensive set of charges for goods and services provided to a patient by the healthcare provider 304. Healthcare claims are typically billed to a third private party insurer or government payer at a gross amount, and the net amount paid is based on a complex set of criteria including targeted contract terms between the healthcare provider 304 and claim payer 306. Because the reimbursement or remittance rates (net and/or gross) and times can vary widely by health provider 304 and claim payer 306, the claim value engine 312 is configured to statistically predict these rates and times based on historical performances of both the health provider/payer combination, as well as industry trends and cross-provider payer information.

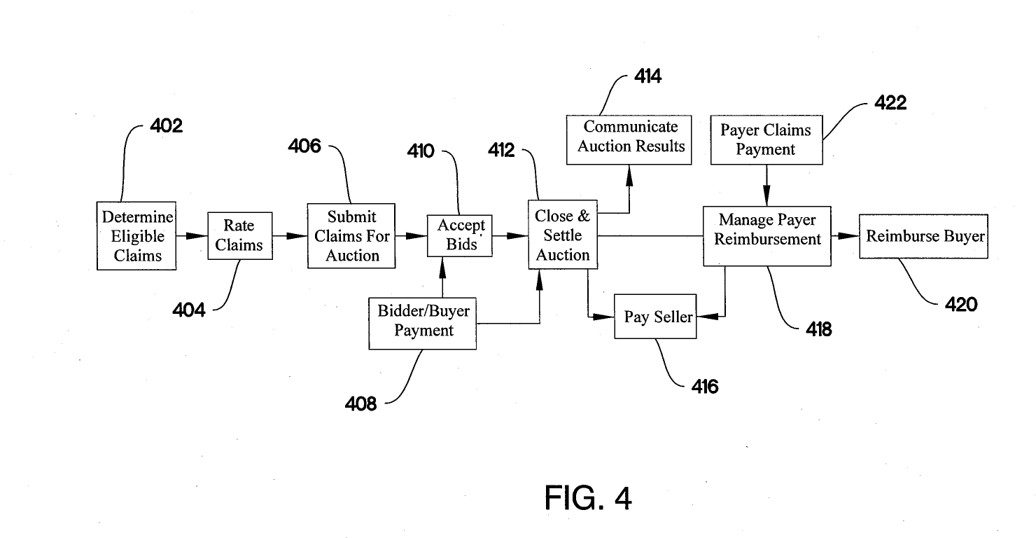

Now referring to FIG. 4, an embodiment of an auction method or process 400 is shown. The auction process 400, which can be performed by software and/or hardware associated with the claim auction platform 302, involves the establishment of the auction participants, such as the healthcare providers 304, the claim payers 306 and the receivable buyers 308, prior to the start of the auction. In accordance with the depicted particular embodiment of auction process 400, a determination or selection of eligible claims, submitted by a variety of sellers or health providers 304, is made, on a daily basis for example, to offer a batch of them for sale, at Block 402. The eligible claims are then rated by the claim value engine 312, at Block 404, prior to being submitted for auction, at Block 406. During a predetermined window of time, claim bids submitted by established buyers 308, at Block 408, are processed and accepted if they meet predetermined auction criteria, at Block 410. Subsequently, at Block 412, the auctions are closed and processed for settlement, and then the auction results are communicated to the auction participating parties, at Block 414. The winning buyers 308 are then responsible for paying the sellers or providers 304 for their claims and paying, if applicable, a buyer's premium for the services provided by the claim clearinghouse 302, at Block 416. Reimbursements of the buyers 308 are then managed and processed, at Block 418 and 420, respectively, after receipt of claim payment, at Block 422. Additionally, at the buyers' discretion, unpaid and underpaid claims can be sent to collections for follow up with the health providers 304 and the claim payers 306. Moreover, in case of payment disagreement or dispute, the sold claims can be withdrawn or repurchased by the claim payers 306.

The selection of an eligible claim involves determining the portions of the corresponding healthcare claim that meet certain predetermined criteria which allow it to be submitted to the auction platform 302 by the health provider 304 or the claim payer 306. In one embodiment, the eligible claims may need to be edited to meet specific auction format requirements before their submission to the auction platform 302. This editing process can be performed by software applications or modules associated with the claim auction platform 310, such as the claim value engine 312. Other claim eligibility criteria may include having an appropriate duration of claims history with the healthcare provider 304 and payer 306 in order to accurately predict reimbursement. The healthcare provider 304 or payer 306 may be excluded because of operational or financial considerations from time to time, such as when the provider submitted claims have undesirably high or low dollar values based on risk vs. platform cost assessment and when payers who do not provide electronic payment information (electronic remittances). Additional claim eligibility criteria may require that eligible claims can only be offered for sale within a predetermined time window, such as a finite number of days, of when they were submitted to the payer 306. From a process standpoint, prior to being offered for sale, an eligible claim is submitted to the payer 306 and a corresponding acknowledgement is provided to the auction platform 310 that the eligible claim has been received by the payer 306. Additionally, a patient eligibility check can be performed to verify that the patient, associated with the eligible claim, was covered under an insurance plan at the time of service. For example, because the payer's adjudication process may include other considerations like the patient's co-pays, deductibles, and lifetime benefits, the expected reimbursement for the eligible claim may not always be known a priori.

In one particular embodiment, the use of historical claims performance, as evaluated or determined by the claim value engine 312, is one approach to valuing the eligible claim for the auction process 300. Moreover, the rating of each eligible claim can be based on a combination of general-population performance (i.e., all providers and payers in aggregate) as well as specific provider-payer performance (i.e., the hospital or health provider 304 submitting the claim and the payer 306 to whom it was submitted). In addition, the auction process 300 can also incorporate market feedback such that shorter term performance fluctuations can adjust the claim ratings more dynamically.

As stated above, the claim rating is comprised of two primary components: (1) the expected reimbursement amount or percentage, and (2) the expected reimbursement time. Accordingly, because the claim value engine 310 is configured to provide a forecast of remittances resulting from the filing of the insurance claim by the healthcare provider 304, the forecast includes predictions regarding both the amounts of any remittances (payments or take-backs) and the timing of such remittances, enabling the health provider 304 to anticipate the cash flows and plan accordingly, and allowing the health provider 304 to monetize expected future cash flows by either selling or borrowing against the future cash flows. Potential lenders and buyers 308 may also use the forecasts to value claims and thus be more willing to lend money against or purchase outright the claims.

In accordance with one or more principles of the invention, for a given claim, historical information, corresponding to the claim provider 304 and payer 306, is used to determine the likely schedule of remittances and their amounts. Key information such as the provider 304, payer 306, claim age, and remittance status are extracted from the claim to be forecast, and then a training cohort or set “Ts” consisting of claims, having common factors associated with claim and payment history, from the past is assembled from the claim and remittance history, stored in the claim database 314, and statistics such as mean and standard deviation of the remittance rate are determined. The resulting remittance schedule is a probability distribution, allowing the grouping of claims into batches, which may reduce uncertainty for the provider 304, and risk for the lender or buyer 308.

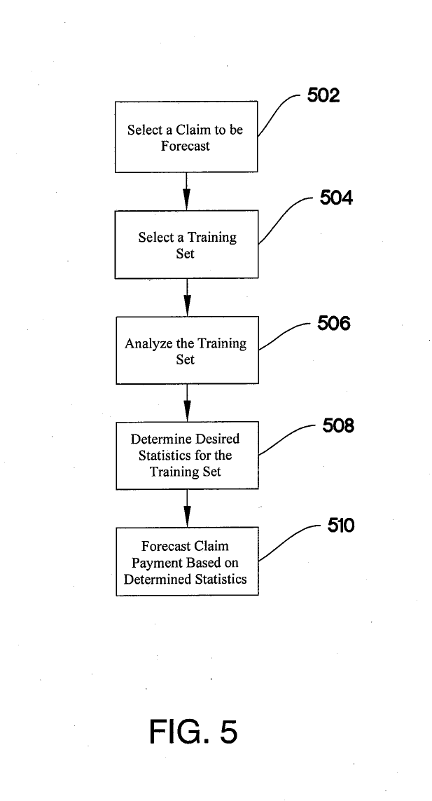

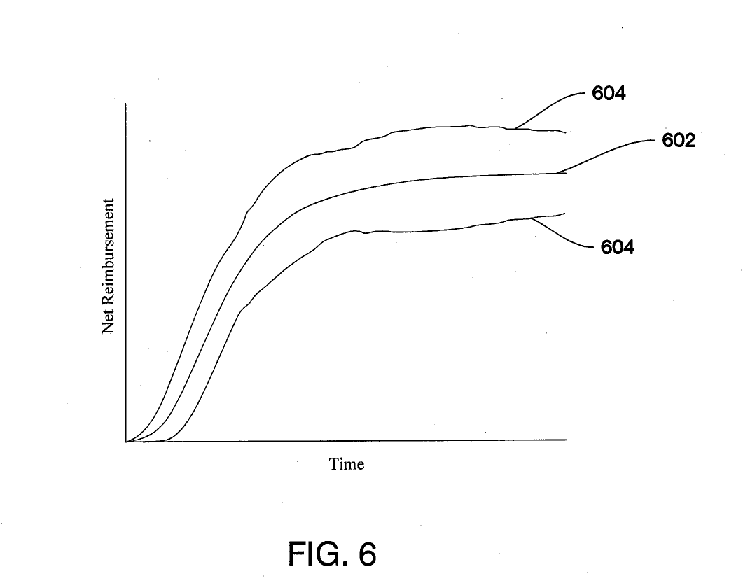

Now referring to FIG. 5, an embodiment of a forecast process 500 for creating a forecast model based on the training set Ts and associated remittances is shown. To forecast payments for a claim “C,” at Block 502, the forecast process 500 utilizes the claim value engine 312 to query the claim database 314 to retrieve a number of claims from which to select the training set Ts and corresponding remittances in order to create or build a forecasting model to predict remittances or cash flows for the target claim C or a batch of claims to be forecast, at Block 504. The training set Ts can be selected at forecast time based on the claims to be forecast, or ahead of time in anticipation of claims that may be forecast in the future. Once the claim training set Ts is selected, the claim value engine 312 is configured to analyze it to retrieve information as to how much and when the training set Ts claims were paid by the payer 306, at Block 506. As will be discussed in further details hereafter, this analysis is characterized by computations to generate statistical numbers and parameters associated with the training set Ts, at Block 508, which will serve or be used as the basis for the forecasting computational step or stage, at Block 510. The claim value engine 312 utilizes these statistical numbers and parameters generated from the training set Ts, and applies them to the claims to be forecast, to produce a forecast for each claim. As stated above, the claim forecast is configured to include a statistical prediction that comprises a derivation of a mean expectation and a standard deviation of a claim payment, with the standard of deviation being used as a measure of uncertainty, as illustrated by curves 602 and 604, respectively, of FIG. 6. As such, in this particular embodiment, the forecast process 500 can be divided in three main processing steps:

(1) A training set selection;

(2) A training set analysis; and

(3) A forecast generation or production.

As stated above, for each claim C to be forecast, key information or attributes such as the provider 304, the payer 306, a claim filing date “t_{c}”, a claim amount “c”, and remittance status are extracted from the claim database 314. This key information is used to form a forecast claim vector, whose elements are comprised of these attributes, which are used by the claim value engine 312 to query the database 314 to find and select stored claims having substantially similar attributes. Additional attributes may further include a primary diagnosis, an attending physician, a bill type, an admission type and source, a patient status, and an admission day of the week and/or hour. One of ordinary skill in the art would understand that a large number of attributes may be lead to identifying an undesirably small training set Ts, which may lead to large standard of deviations, i.e., large payment uncertainties. Moreover, for the sake of simplicity, hereafter the claims that have attributes similar to those associated with the claim C to be forecast will be referred to as “similar claims.”

In the forecasting step, the net claim reimbursement or payment is evaluated, by the claim value engine 312, at some time horizon “t₀+h” into the future from an initial time or day t₀, where “h” represents a number of days into the future for the claim that is “t₀−t_{c}” days old. Thus, each of the claims selected for the training set Ts needs to be at least “t₀−t_{c}+h” days old to ensure that a substantially complete remittance history on each of the training set claim has been captured and is stored in the database 314. In addition, the training set Ts can be sized by either selecting a specific number “n” of claims filed h days before the filing date t_{c} of the claim to be forecast, or by selecting all similar claims filed during “l” number of days, i.e., all claims filed between the “t_{c}−h−l” day and the “t_{c}−h” day. Hereafter, the training set Ts, associated with all the claims selected during “l” number of days, is referred to as the training set Ts of cohort length “l” or as “training cohort C_{T}.” As such, the training cohort C_{T} consists of all substantially similar claims filed on or after t_{c}−h−l and before t_{c}−h, and is represented as follows:

$${C}_{T} = \{ {c}^{′} \vert \begin{matrix}{c}^{′} is similar to c \\ and \\ {t}_{c} - h - l \leq {t}_{c} , < {t}_{c} - h\end{matrix} \} \qquad Equation 1$$

When the claim C is paid to the provider 304 with a sequence of remittances r₁, r₂, . . . , rₘ, where is an integer number m≧0. Typically, only one remittance (m=1) is expected. That is, either a payment (|r₁|>0) or a denial (|r₁|=0), but it also is possible that the payer 306 may reconsider its remittance and issue subsequent remittances (m≧1), which might be take-backs (|r₁|<0). Alternatively, the payer 306 might not respond to the claim at all (m=0). Although the latter payer response is not normal or typical, there can be legitimate reasons for this claim non-payment. That is, the claim C may not have been received by the payer 306, the claim C may have been cancelled by the provider 304, the claim C may have been lost by the payer's systems, or the remittance may have been lost in transit from the payer 306 back to the provider 304.

Each claim “C′” in the training cohort C_{T} has a filing date t_{c′}, a charge amount |c′| (i.e., the total of charges on the claim C′ and a (possibly empty) set of reimbursements “R_{c′}.” Each reimbursement “r′” which belongs to the R_{c′} set of reimbursements includes a payment date “t_{r′}” and a payment amount “|r′|.” Since only the reimbursements |r′|, received between days t₀−t_{c} and t₀−t_{c}+h, are of interest, the claim value engine 312 is configured to evaluate a net reimbursement amount “NR” for each claim C′ as follows:

$${s}_{j} = {\sum }_{{c}^{′} ∈ {C}_{T}} {\vert {c}^{′} \vert}^{j} \cdot {NR ( {C}^{′} )}^{j} with j = 0 , 1 , 2 \qquad Equation 3$$

As |c′| represents the total amount of charges on claim C′, the claim value engine is configured to evaluate power sums s₀, s₁, and s₂, for all claims C′ of the training cohort C_{T} as follows:

$$\begin{matrix}E ( NRR ) = \frac{{s}_{1}}{{s}_{0}} & Equation 4 \\ Var ( NRR ) = ( \frac{n}{n - 1} ) ( \frac{{s}_{0} {s}_{2} - {s}_{1}^{2}}{{s}_{0}^{2}} ) & Equation 5\end{matrix}$$

Utilizing these sums, the claim value engine 312 is configured to compute estimates for the mean and variance of a net reimbursement rate “NRR,” as follows:

$$\begin{matrix}E ( NRR ) = \frac{{s}_{1}}{{s}_{0}} & Equation 4 \\ Var ( NRR ) = ( \frac{n}{n - 1} ) ( \frac{{s}_{0} {s}_{2} - {s}_{1}^{2}}{{s}_{0}^{2}} ) & Equation 5\end{matrix}$$

Once the mean E(NRR) and variance Var(NRR) of the net reimbursement rate NRR have been derived, then the claim value engine 312 is configured to multiply each one of them by the claim amount |c| to generate the mean “E(NR(c))” and the standard deviation “S.D.(NR(c)” of the subject claim C, as follows:

E(NR(c))=|c|·E(NRR) Equation 6

S.D.(NR(c))=|c|·\sqrt{Var(NRR)} Equation 7

As known to one of ordinary skill in the art, an insurance claim that has already been paid may not have a reimbursement future comparable to another insurance claim which has not yet been remitted. A paid claim is unlikely to have any additional future remittance, since most claims are only remitted once, but if it does get a future remittance, it is possible for it to be negative. Such negative remittance is referred to as a “take-back.” On the other hand, an unremitted claim is unlikely to have a negative future net reimbursement, since the payer 306 cannot take back remittances which it has not already given. Thus, in accordance with one or more principles of the invention, the claim C to be forecast can be classified as unremitted, paid, or denied, and, as stated above, the forecast process 500 uses only claims which had the same remittance status as the subject claim C being forecast.

Accordingly, a claim is considered “unremitted” on a certain date if no remittances have been received for the claim prior to the date in question, and a claim is considered “paid” on a certain date if the claim has received at least one remittance prior to the date and the net of all such remittances is positive. A claim is considered to be “denied” on a certain date if it has received at least one remittance prior to the date and the net of all such remittances is zero or negative. As such, all claims can be classified into one and only one of these remittance categories on any given date as given by the following remittance status function RemitStat(c,t), as follows:

$$RemitStat ( c , t ) = \{ \begin{matrix}‘ unremitted ’ & if ∄ r ∈ {R}_{c} \vert {t}_{r} < t \\ ‘ paid ’ & if {\sum }_{r ∈ {R}_{c} \vert {t}_{r} < t} \vert r \vert > 0 \\ ‘ denied ’ & if {\sum }_{r ∈ {R}_{c} \vert {t}_{r} < t} \vert r \vert \leq 0\end{matrix} \qquad Equation 8$$

Since the forecast process 500 uses only claims which had the same remittance status as the subject claim C being forecast, then the claim value engine 312 is configured to select for the training cohort C_{T} claims with matching remittances statuses, as follows:

$${C}_{T} = \{ {c}^{′} \vert \begin{matrix}{c}^{′} is similar to c \\ and \\ {t}_{c} - h - l \leq {t}_{{c}^{′}} < {t}_{c} - h \\ and \\ RemitStat ( {c}^{′} , {t}_{{c}^{′}} + {t}_{0} - {t}_{c} ) = RemitStat ( c , {t}_{0} )\end{matrix} \} \qquad Equation 9$$

During the forecasting process, the evaluation of the RemitStat function requires cycling through claim remittances, stored in the database 314, to meet the computational requirements of the power sums s₀, s₁, and s₂ given by Equation 3, so that the assembling of the training cohort C_{T} is performed in accordance with Equation 1 and the power sums s₀, s₁, and s₂ are computed for all three remittance statuses.

As known to one of ordinary skill in the art, if a random variable is discrete, then the probability mass function (PMF) is the probability that the discrete random variable assumes an exact value. Whereas, if the random variable is continuous, then the probability density function (PDF) is the probability that the continuous random variable assumes a value over an interval or range. In the case of forecasting claim payments, the PMF describes the probability of an event occurring on day t. For the probability functions discussed and determined herein, the origin is some event such as a claim being filed or a remittance being received or paid, not necessarily today but rather, as discussed above, the origin can be the initial day t₀. As such, the PMF f(t) is the probability of an event T occurring t days after the origin event, and f(0) is the probability of the event occurring on the same day as the origin, i.e., t₀, and f(t) is defined as follows:

f(t)=Pr(T=t) Equation 10

Because when forecasting claim payments or remittances, an event occurring at time or day T=t may actually occur anywhere in the range T∈[t, t+1), then f(t) can be expressed as follows:

f(t)=Pr (t≦T<t+1) Equation 11

The corresponding cumulative density function (CDF) F(t) associated with the PMF f(t), which is the probability that a claim can be paid prior to day t, is expressed as follows:

$$\begin{matrix}F ( t ) = Pr ( T < t ) \\ = {\sum }_{τ = 0}^{t - 1} f ( τ )\end{matrix} \qquad Equation 12$$

This CDF F(t) is a monotonically non-decreasing function with F(0)=0 (assuming a claim cannot be remitted before it is sent) and a usual range of [0,1], though if an event can occur multiple times, F(t) can grow above 1. Equation describes the CDF F(t) in terms of the PMF f(t), but the f(t) can also be described by the F(t), as follows:

f(t)=F(t+1)−F(t) Equation 13

Further, a survivor function S(t) can be defined as the complement to the CDF F(t), which is applicable to events occurring only once, is expressed as follows:

S(t)=Pr(T≧t) Equation 14

When the claim payment forecasting involves events that occur multiple times, then the CDF F(t) may reaches values that are greater than 1 (one), whereas the survival function S(t) may not exist.

In the above discussion, the claim payment forecast is produced, by the claim value engine 312, for a single day, that is h days from the chosen initial day t₀. When intermediate claim forecasts are needed or desired, as when daily cash flows need to be predicted or evaluated, then either the same training cohort C_{T} is used and the corresponding cash flows are determined over the course of the forecast period, or different training cohorts C_{Tj}, with j=1,2, . . . , are assembled for each day in the forecast period. Since the training cohort C_{T} includes claims at least t₀−t_{c}+h days old, assembling different training cohorts C_{Tj} for lower values of h has the advantage that more recent claims are used to forecast the near future from the chosen initial day t₀, making the corresponding forecasts more reactive to changes in the claim payment behavior. Using this different training cohort approach, the implied cash flows produced by subtracting the forecast for day h−l from that of day h reflects more the variance between the two training cohorts than it does any cash flows. Furthermore, if there has been a payment regime change in the last h+l days that affected claim reimbursement, then this different training cohort approach can accurately reflect the change near-term, but in the long-term, there would be implied cash flows that reversed the effects of the change. For example, if the payer 306 increased its payment rate from 30% to 50%, then forecasts using claims after the change would reflect the 50% rate in the near term, but longer term forecasts can still reflect the 30% rate, with an implied take-back in the interim of 40% of money initially paid. Therefore, by instead forecasting the cash flows, adjustments to short-term claim forecasts can be made, which are not reversed by the long-term claim forecasts. As such, instead of computing a single net reimbursement for claim C which consists of the sum of all remittances received within a period situated between days t₀−t_{c} and t₀−t_{c}+h, as in Equation 2, the net remittances NR for each claim C′ are determined for each day t within that period, as follows:

$$NR ( {c}^{′} , t ) = {\sum }_{{( t , ρ ) ∈ {R}_{{c}^{′}}}_{t = {t}_{{c}^{′}} + {t}_{0} - {t}_{c} + t}} ρ for t ∈ [ 0 , h ) \qquad Equation 15$$

Once the net remittances NR are determined, a net reimbursement rate for each day t in that period is computed, and these daily net reimbursement rates are then summed together to produce a net or cumulative reimbursement rate by day h, as follows:

$$\begin{matrix}{s}_{j , t} = \sum {\vert {c}^{′} \vert}^{1 - j} \cdot {NR ( {c}^{′} , t )}^{j} & Equation 16 \\ E ( NRR @ t ) = \frac{{s}_{1 , t}}{{s}_{0 , t}} & Equation 17 \\ E ( NRR ) = {\sum }_{τ = 0}^{h - 1} E ( NRR @ τ ) & Equation 18\end{matrix}$$

As for the variance, summing variances implies that the events are independent, which may not be the case when claim forecasting since a payment one day may greatly reduce the chances of another payment the next day. As such, Equation 5 is therefore still a valid way of computing the variance, since it does take into account the covariances throughout the period.

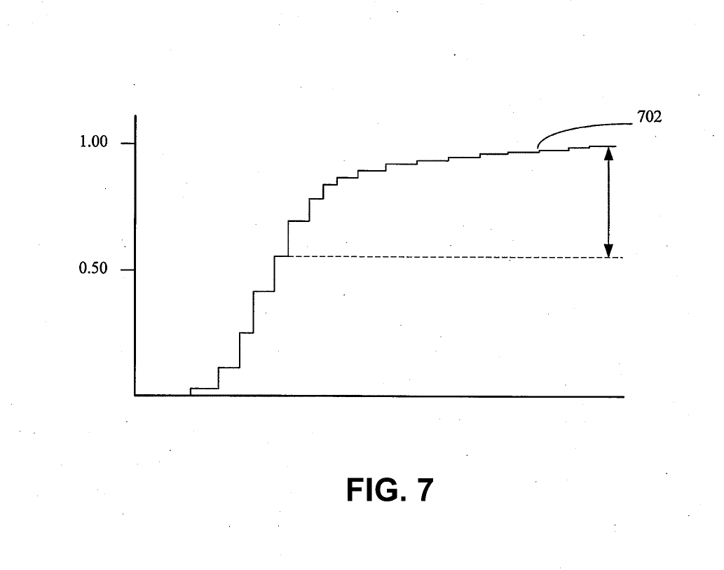

Now referring to FIG. 7, in attempting to reduce the computational requirements of the prior CDF F(t) and PMF f(t) based forecasts, a single payment curve 702 may be determined to find the position of the claim to be forecast on the curve 702. In order to predict the probability of a claim being paid by a selected time horizon tₕ, the value of F(t) at the claim's current day t₀ can be subtracted from the value of F(t) at day tₕ+l, as follows:

Pr(t₀≦T<tₕ+1)=F(tₕ+1)−F(t₀) Equation 19

In one exemplary embodiment, the payer 306 may provide remittances at days t₁ and t₂ with a probability equal to 0.5 each. In this payment scenario, the PMF f(t) and the CDF F(t) are as follows:

$$f ( t ) = \{ \begin{matrix}0.5 & if t ∈ \{ {t}_{1} , {t}_{2} \} \\ 0 & otherwise\end{matrix} \\ F ( t ) = \{ \begin{matrix}0 & if t \leq {t}_{1} \\ 0.5 & if {t}_{1} < t \leq {t}_{2} \\ 1 & if t > {t}_{2}\end{matrix}$$

That is, the claim C is paid with 100% probability by day t₂, and between days t₁ and t₂ the claim C is considered to have only a 50% probability of being paid by day t₂, as expressed in the following computation:

$$\begin{matrix}Pr ( {t}_{1} + 1 \leq T \leq {t}_{2} + 1 ) = F ( {t}_{2} + 1 ) - F ( {t}_{1} + 1 ) \\ = 1 - 0.5 \\ = 0.5\end{matrix}$$

Instead of using the CDF F(t), the survival function S(t) can be used to analysis this scenario of claim payment. For this analysis, S(t) expressed as follows:

$$S ( t ) = \{ \begin{matrix}1 & if t \leq {t}_{1} \\ 0.5 & if {t}_{1} < t \leq {t}_{2} \\ 0 & if t > {t}_{2}\end{matrix}$$

By dividing the PMF f(t) by the survival function S(t), the claim value engine 312 configure a hazard function λ(t) for the period involving days t₁ and t₂, as follows:

$$λ ( t ) = \{ \begin{matrix}0.5 & if t = {t}_{1} \\ 1 & if t = {t}_{2} \\ 0 & if t < {t}_{2} and t \neq {t}_{1}\end{matrix}$$

As such, in this payment scenario, the hazard function 20 indicates that an unremitted claim C has a 50% probability of being paid at day t₁, but if still unremitted by day t₂ then claim C has a 100% probability of being paid. Based on its definition, the hazard function λ(t) is undefined for days t>t₂.

In accordance with one embodiment, the CDF F(t) is used to determine the first remittance event for claim C. Without loss of generality, every claim is assumed to be answered or paid by exactly one remittance. By setting t₀=0 as the day when the claim C is send to the payer 306, as discussed above, the CDF F(t) can be used to determine the probability of the claim C being paid. On the other hand, in the forecasting of an older claim Cₒ, characterized by t₀>0, the probability of receiving a payment for Cₒ between t₀ and t₀+t is as follows:

$$\begin{matrix}p ( t ) = Pr ( {t}_{0} \leq T < {t}_{0} + t ) \\ = \{ \begin{matrix}Pr ( {t}_{0} \leq T < {t}_{0} + t \vert T < {t}_{0} ) & if T < {t}_{0} \\ Pr ( {t}_{0} \leq T < {t}_{0} + t \vert T \geq {t}_{0} ) & if T \geq {t}_{0}\end{matrix}\end{matrix}$$

Clearly, if T<t₀, then t₀ cannot be less than or equal to T, so Pr (t₀≦T<t₀+t|T<t₀) is equal to zero. That is, if the single remittance was received prior to t₀, then this single remittance cannot be expected to be received after t₀. However, for the case where the remittance has not yet been received, the claim value engine 312 is configured to employ the conditional probability:

Pr(B|A)=Pr(A∩B)/Pr(A)

which represents the probability of the occurrence of an event B conditional on the occurrence of an event A, in order to compute the probability p(t) of the first remittance event, as follows:

$$\begin{matrix}Pr ( {t}_{0} \leq T < {t}_{0} + t \vert T \geq {t}_{0} ) = \frac{Pr ( {t}_{0} \leq T < {t}_{0} + t )}{Pr ( T \geq {t}_{0} )} \\ = \frac{F ( {t}_{0} + t ) - F ( {t}_{0} )}{S ( {t}_{0} )}\end{matrix}$$

which leads to:

$$p ( t ) = \{ \begin{matrix}0 & if T < {t}_{0} \\ \frac{F ( {t}_{0} + t ) - F ( {t}_{0} )}{S ( {t}_{0} )} & if T \geq {t}_{0}\end{matrix} \qquad Equation 20$$

Based on Equation 20, one can deduce that when t₀=0, then p(t)=F(t), i.e., p(0)=F(0).

As such, if R is the amount of the expected remittance, then the claim value engine 312 is configured to determine the value of future initial payments on the claim C prior to day t is as follows:

E (future initial payments)=R·p(t) Equation 21

Moreover, the expected remittance R can be expressed in terms of a remittance rate r, which represents a fraction of the total amount of charges of the claim C, as follows;

E (future initial payments)=r·|c|·p(t) Equation 22

Above, it was assumed that every claim C is answered by a remittance, that is lim_{t→∞}F(t)=1. However, there are various legitimate reasons for the claim C to not receive a remittance. The received remittance is modeled as being received within a certain time horizon tₕ because typically the provider 304 is not willing to wait for an unlimited period of time or days to receive a remittance. As such, since the time horizon tₕ is selected to be finite, the CDF F(tₕ) may or may not be equal to 1. That is, regardless of whether claims are answered by remittances or not, a remittance may not be guaranteed to be received within the time horizon tₕ.

### Forecasting Multiple Claims

If the probability distribution were normal, then this standard deviation S.D.(NR(c), of the predicted net reimbursement of the subject claim C, can be used to infer probabilities of the net reimbursement being within desired ranges. However, the probability distribution may not be normal. On the other hand, if a large enough number of claims is forecasted, and assuming that their payments are independent, then by the Central Limit Theorem, the distribution can be approximately normal, and normal assumptions can be made regarding probabilities of the net reimbursement falling within desired ranges. Moreover, if similar claims C are grouped into batches for forecasting, the training cohorts C_{T} for similar claims filed on the same day and having the same remittance status will be identical. Further, computational efficiencies can be obtained by assembling a single training cohort C_{T} only once and applying it to all such similar claims. By computing the first and second order power-sums of the claim amounts, |C|ⱼ=Σ|c|^{j}, with j=1, 2, the claim value engine 312 is configured to compute the forecast by modifying Equations 6 and 7, as follows:

E(ΣNR(c))=|C|₁·E(NRR) Equation 23

S.D.(ΣNR(c))=\sqrt{|C|₂ Var(NRR)} Equation 24

When computing the CDF F(t), the error can be significant. Moreover, when the values of F(t) do not fall within the interval {0,1}, there may not be a CDF F(t) that can substantially predict whether the claim C may be remitted by day t or not, since the claim C is either remitted or not, but the function F(t) gives a probability. The effects of this uncertainty may be mitigated by grouping multiple claims into a batch and producing a forecast for the entire batch. For a large enough batch, the CDF F(t) does provide an accurate estimate of yield, and the bounds of this accuracy can be computed. The probability that the claim C is paid by day t is given by Equation 20. In large enough claim batches, the probability distribution becomes normal with batch variance related to the variance of the constituent claims (Central Limit Theorem). So computing the variance of p is helpful:

$$\begin{matrix}Var ( p ) = {p}^{2} \cdot ( 1 - p ) + {( 1 - p )}^{2} \cdot p \\ = p \cdot ( 1 - p )\end{matrix}$$

which leads to: S.D.(p)=\sqrt{p(1−p)} Equation 25

As can be seen from Equation 25, when p belongs to the set {0, 1}, which means that the claim C has already been remitted, the S.D.(p) has a range of [0, 0.5], and reaches its maximum at p=0.5. Further, with an expected payment R and a probability of payment p, claim C has an expected value of future remittances of Rp, with a standard deviation of R·√(p(1−p)). As such, for the forecast of multiple batch claims, the claim value engine 312 is configured to use these expected remittance and standard deviation values of each claim in the batch to compute the expected value and variance for the entire batch, as follows:

$$E ( future payments of batch ) = {\sum }_{claim i n batch} E ( future payments of claim )$$

$$S . D . ( future payment of batch ) = \sqrt{{\sum }_{claim i n batch} S . D . {( future payments of claim )}^{2}}$$

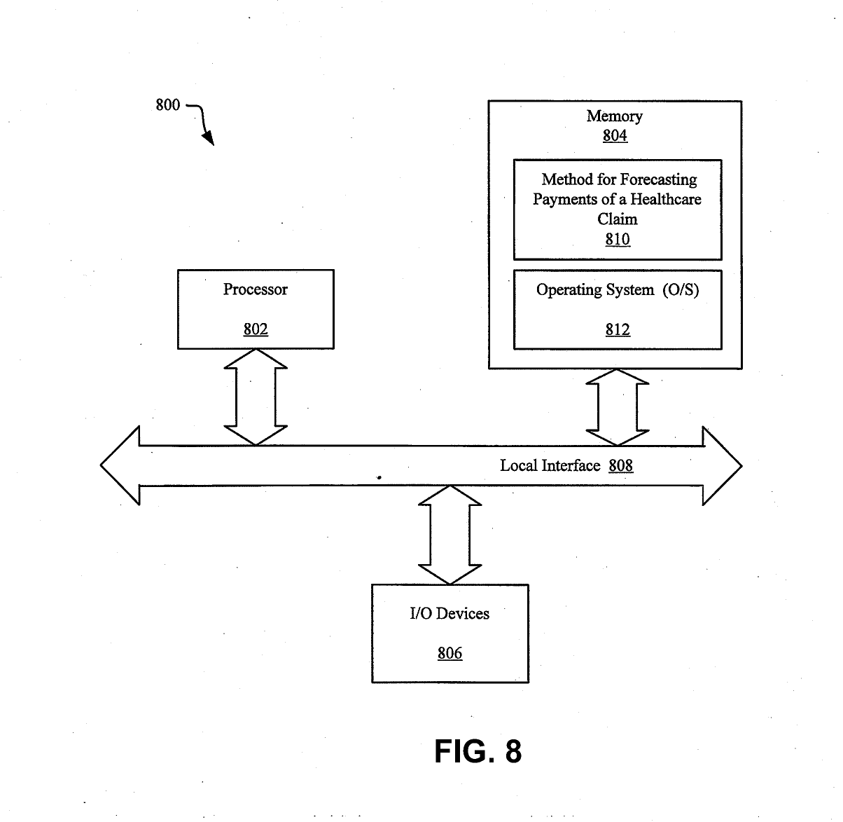

FIG. 8 illustrates a block diagram of a computer 800. The computer 800 may be any one of the user computer 802, the claim value server 104, the health service provider server 106, the claim payer server 108 or the receivable buyer server 110 of FIG. 1, or any computer associated with the networked system 100. Without loss of generality and as an exemplary computer, the claim value sever 104 is discussed hereafter. The computer 800 may include a memory element 804. The memory element 804 may include a computer readable medium for implementing the method 810 for forecasting payments and remittance times of health care claims.

The method 810 may be implemented in software, firmware, hardware, or any combination thereof. For example, in one mode, the method 810 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 800 may be representative of any computer in which the method 810 resides or partially resides.

Generally, in terms of hardware architecture, as shown in FIG. 8, the computer 800 includes a processor 802, memory 804, and one or more input and/or output (I/O) devices 806 (or peripherals) that are communicatively coupled via a local interface 808. The local interface 808 may be, for example, but is not limited to, one or more buses or other wired or wireless connections, as is known in the art. The local interface 808 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 802 is a hardware device for executing software, particularly software stored in memory 804. Processor 802 can be any custom made or commercially available processor, a central processing unit (CPU), an auxiliary processor among several processors associated with the computer 800, a semiconductor based microprocessor (in the form of a microchip or chip set), another type of microprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor 802 may also represent a distributed processing architecture such as, but not limited to, SQL, Smalltalk, APL, KLisp, Snobol, Developer 200, MUMPS/Magic.

Memory 804 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 804 may incorporate electronic, magnetic, optical, and/or other types of storage media. Memory 804 can have a distributed architecture where various components are situated remote from one another, but are still accessed by processor 802.

The software in memory 804 may include one or more separate programs. The separate programs comprise ordered listings of executable instructions for implementing logical functions. In the example of FIG. 8, the software in memory 804 includes the method 810 in accordance with the invention, a suitable operating system (O/S) 812. A non-exhaustive list of examples of suitable commercially available operating systems 812 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Hewlett-Packard Company, Windows CE, and Mobile 7 available from Microsoft Corporation, Symbian from Nokia, Android from Google, Inc, and Apple iOS for iPhones, iPod Touch, and iPads from Apple, Inc). Operating system 812 essentially controls the execution of other computer programs, such as the method 810, and provides scheduling, input-output control, file and data management, memory management, and communication control and related services.

The method 810 may be a source program, executable program (object code), script, or any other entity comprising a set of instructions to be performed. When a “source” program, the program needs to be translated via a compiler, assembler, interpreter, or the like, which may or may not be included within the memory 804, so as to operate properly in connection with the O/S 812. Furthermore, the method 810 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada. In one embodiment, the method 810 is written in T-SQL. Functional programming languages, such as Haskell and Erlang, can also be used to implement embodiments of the present invention.

The I/O devices 806 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 806 may also include output devices, for example but not limited to, output modules for PLCs, a printer, bar code printers, displays, etc. Finally, the I/O devices 806 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computer 800 is a PC, workstation, PDA, or the like, the software in the memory 804 may further include a basic input output system (BIOS) (not shown in FIG. 3). The BIOS is a set of essential software routines that initialize and test hardware at startup, start the O/S 812, and support the transfer of data among the hardware devices. The BIOS is stored in ROM so that the BIOS can be executed when computer 800 is activated.

When computer 800 is in operation, processor 802 is configured to execute software stored within memory 804, to communicate data to and from memory 804, and to generally control operations of computer 800 pursuant to the software. The method 810, and the O/S 812, in whole or in part, but typically the latter, may be read by processor 802, buffered within the processor 802, and then executed.

When the method 810 is implemented in software, as is shown in FIG. 8, it should be noted that the method 810 can be stored on any computer readable medium for use by or in connection with any computer related system or method, although in one preferred embodiment, the method 810 is implemented in a centralized application service provider arrangement. In the context of this document, a computer readable medium is an electronic, magnetic, optical, or other physical device or means that can contain or store a computer program for use by or in connection with a computer related system or method. The method 810 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the method 810 is implemented in hardware, the method 810 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In accordance a particular embodiment, in summary to forecast a claim's net reimbursements for a future date, such as tomorrow for example, the training cohort C_{T} can include the last sixty (for example) days' worth of claims with the same payer 306 and provider 304 as the claim C to be forecast, and that are at least one day older than the claim to be forecast, and that had the same remittance status as the claim C to be forecast when they were the same age as the claim to be forecast. The training cohort C_{T} claims' charges are valued as they were when the claims were the same age as the claim C to be forecast, and the training cohort C_{T} net reimbursements for only the day when the claims were one day older than the claim C to be forecast are tallied. The resulting mean and standard deviation of the remittance rate are multiplied by the total of charges for the claim C to be forecast to compute the mean and standard deviation of the expected net reimbursement probability distribution.

It should be emphasized that the above-described embodiments of the invention, particularly, any “preferred” or “particular” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

What is claimed is:

1. A method for forecasting remittances of a target claim filed for reimbursement of a healthcare service provided to an insured patient, the method comprising:
determining, using a data extraction module running on a processor, a set of data associated with the target claim, the set of data including a service provider, a claim payer, a claim amount, an age, and a remittance status;
querying, using a claim value engine running on the processor, a database using the set of data associated with the target claim;
based on said querying, selecting, using the claim value engine, a plurality of claims stored in the database that (i) are associated with the service provider and the claim payer of the target claim, (ii) are older than the target claim by at least a predetermined period of time, and (iii) have a previous remittance status, from when the selected plurality of claims were the age of the target claim, that is the same as the remittance status of the target claim, wherein each of the selected plurality of claims has a claim amount, a plurality of reimbursement amounts, and a plurality of corresponding reimbursement dates;
evaluating, using the claim value engine, a mean expectation value for a predetermined date based on the plurality of reimbursement amounts of the plurality of claims; and
determining, using the claim value engine, a reimbursement value of the target claim that is to be received by the predetermined date by multiplying the evaluated mean expectation value by the claim amount.

2. The method of claim 1, further comprising:
evaluating, using the claim value engine, a standard deviation value for the predetermined date based on the plurality of reimbursement amounts of the plurality of claims; and
determining, using the claim value engine, a measure of uncertainty of the reimbursement value by computing the square root of the square of the evaluated standard deviation value multiplied by the second order power-sum of the claim amount.

3. The method of claim 1, further comprising:
grouping, using the claim value engine, claims filed on the same day and having the same remittance status;
computing, using the claim value engine, first and second order power-sums of the claim amounts within the grouping; and
computing, using the claim value engine, a forecast of the remittances using the first and second order power-sums.

4. The method of claim 1, wherein the remittance status of the target claim can be one of a paid status, a denied status and an unremitted status.

5. The method of claim 1, wherein each of the selected plurality of claims was filed during an interval of time equal to a number of consecutive days ending on a predetermined date, thereby defining a set of claims.

6. A system for forecasting remittances of a target claim filed for reimbursement of a healthcare service provided to an insured patient, the system comprising:
a data extraction module configured to extract a set of data associated with the target claim from a claim database, the set of data including a service provider, a claim payer, a claim amount, an age, and a remittance status; and
a claim value engine configured to:
query the claim database using the set of data associated with the target claim,
select, based on said query, a plurality of claims stored in the claim database that (i) are associated with the service provider and the claim payer of the target claim, (ii) are older than the target claim by at least a predetermined period of time, and (iii) have a previous remittance status, from when the selected plurality of claims were the age of the target claim, that is the same as the remittance status of the target claim, wherein each of the selected plurality of claims has a claim amount, a plurality of reimbursement amounts, and a plurality of corresponding reimbursement dates,
evaluate a mean expectation value for a predetermined date based on the plurality of reimbursement amounts of the plurality of claims, and
determine a reimbursement value of the target claim that is to be received by the predetermined date by multiplying the evaluated mean expectation value by the claim amount.

7. The system of claim 6, wherein the claim value engine is further configured to:
evaluate a standard deviation value for the predetermined date based on the plurality of reimbursement amounts of the plurality of claims; and
determine a measure of uncertainty of the reimbursement value by computing the square root of the square of the evaluated standard deviation value multiplied by the second order power-sum of the claim amount.

8. The system of claim 6, wherein the claim value engine is further configured to:
group claims filed on the same day and having the same remittance status;
compute first and second order power-sums of the claim amounts within the grouped claims; and,
compute a forecast of the remittances using the first and second order power-sums.

9. The system of claim 7, wherein the remittance status of the target claim can be one of a paid status, a denied status and an unremitted status.

10. The system of claim 6, wherein each of the selected plurality of claims was filed during an interval of time equal to a number of consecutive days ending on a predetermined date, thereby defining a set of claims.

11. A system for forecasting remittances of a target claim filed for reimbursement of a healthcare service provided to an insured patient, the system comprising:
a memory configured to store a database comprising information about a plurality of claims, the information including a claim amount, a plurality of reimbursement amounts, and a plurality of corresponding reimbursement dates for each of the plurality of claims; and
a processor in communication with the database, the processor for executing:
a data extraction module configured to extract a set of data associated with the target claim from the database, the set of data including a service provider, a claim payer, a claim amount, an age, and a remittance status, and
a claim value engine configured to:
query the database using the set of data associated with the target claim;
based on said query, select a subset of the plurality of claims that (1) are associated with the service provider and the claim payer of the target claim, (2) are older than the target claim by at least a predetermined period of time, and (3) have a previous remittance status, from when the selected plurality of claims were the age of the target claim, that is the same as the remittance status of the target claim;
evaluate a mean expectation value for a predetermined date based on the plurality of reimbursement amounts of the selected subset of the plurality of claims; and
determine a reimbursement value of the target claim to be received by the predetermined date by multiplying the evaluated mean expectation value by the claim amount.

12. The system of claim 11, wherein the processor is configured to be in communication with an electronic auction platform which in turn is configured to be in communication with a healthcare provider computing device, a claim payer computing device, and a receivable buyer computing device.

13. The system of claim 11, wherein the claim value engine is further configured to a standard deviation value for the predetermined date based on the plurality of reimbursement amounts of the selected subset of the plurality of claims, and determines a measure of uncertainty of the reimbursement value by multiplying the evaluated standard deviation value by the claim amount.

14. The system of claim 11, wherein the remittance status of the target claim can be one of a paid status, a denied status and an unremitted status.

15. The system of claim 11, wherein each of the selected subset of the plurality of claims has been filed during an interval of time equal to a number L of consecutive days, dated prior to the at least a predetermined period of time, thereby defining a training set of claims having a length L.
